(19) United States
(12) Patent Application Publication
(10) Pub. No.: US 2026/0251094 A1
(43) Pub. Date: Aug. 27, 2026

(54) ELECTRICALLY CONTROLLED AIR THROTTLE BODY STRUCTURE

(71) Applicant: Guangdong HuaKong Auto Tech Co., Ltd., Dongguan (CN)

(72) Inventor: HongJun MA, Dongguan (CN)

(21) Appl. No.: 19/063,159

(22) Filed: Feb. 25, 2025

(30) Foreign Application Priority Data
Aug. 9, 2024 (CN) 202421927070.7

(51) Int. Cl. F02D 9/10; F02M 37/00

(52) U.S. Cl. CPC F02D 9/1035; F02D 9/1005; F02M 37/0047

(57) ABSTRACT

An electrically controlled air throttle body structure is provided, which includes a body. The body has air flow paths. A butterfly valve, an atomization ring, and a nozzle are disposed. A first end cover forming a first cavity is fixedly fitted to a left or right side of the body. A first fuel line configured to supply fuel to the nozzle is formed on an inner wall of the first end cover. A first interface protrudes from a side wall of the body opposite to the first end cover. A second interface protrudes from a side, of the inner wall of the first end cover, toward the body. The second interface communicates with the first fuel line. A tube-like connection piece communicating with the second interface is plugged and fitted between the first interface and the second interface. The problem sensor installation and wiring in narrow space are resolved.

This application claims to the benefit of priority from Chinese Application No. 202421927070.7 with a filing date of Aug. 9, 2024. The content of the aforementioned applications, including any intervening amendments thereto, are incorporated herein by reference.

### TECHNICAL FIELD

The present utility model relates to the technical field of automobile air throttles, and specifically, to an electrically controlled air throttle body structure.

### BACKGROUND

In the repacking field of fuel automobiles, to improve a fuel utilization rate, an electrically controlled air throttle body is introduced on the market, to precisely control a fuel injection quantity, an opening degree of a butterfly valve, and the like. However, the fuel injection quantity is further affected by fuel supply pressure. To control the fuel injection quantity more precisely, pressure of a fuel supply line further needs to be monitored, to adjust the fuel injection quantity based on the fuel supply pressure. However, space in an air throttle body is very limited, it is difficult to install and cable a fuel pressure sensor during assembly, and during installation, it is easy for each component to press a wire to cause a risk of a short circuit. Therefore, all existing sensors for monitoring the pressure of the fuel supply line are installed on an external fuel line. In this case, the external fuel line needs to be additionally repacked. Generally, the fuel pressure sensor is added to the external fuel line by using a tee-junction, and a fuel pressure meter is disposed to display real-time pressure. In such a manner, not only a repacking operation is inconvenient, but also a fuel injection quantity cannot be adjusted in real time when the pressure of the fuel supply line fluctuates. Therefore, an improvement is required.

### SUMMARY

An objective of the present utility model is to provide an electrically controlled air throttle body structure that is convenient to install and can adjust a fuel injection quantity in real time.

To implement the above objective, the present utility model uses the following technical solutions.

An electrically controlled air throttle body structure is provided, including a roughly rectangular body, the body having several air flow paths that are arranged in parallel and that run up and down, and a butterfly valve for controlling a ventilation quantity, atomization rings for causing fuel to be atomized and to enter the air flow path, and several nozzles that are disposed on a left or right side or two sides of the body and communicate one-to-one with the atomization rings being disposed on the air flow path, a first end cover forming a first cavity is fixedly fitted to a left or right side of the body, a first fuel line configured to supply fuel to the nozzle is formed on an inner wall of the first end cover, a first interface protrudes from a side wall of the body opposite to the first end cover, a second interface protrudes from a side, of the inner wall of the first end cover, toward the body, the second interface communicates with the first fuel line, a tube-like connection piece communicating with the second interface is plugged and fitted between the first interface and the second interface, and a fuel pressure sensor is further installed on the connection piece in vertical communication.

In a preferred solution, a panel forming a second cavity is further fixedly fitted on a front side of the body, a line board is installed in the second cavity, a via is provided between the first cavity and the second cavity, and a wire of the nozzle and a wire of the fuel pressure sensor both pass through the via and are electrically connected to the line board.

In a preferred solution, two groups of the nozzles run through a side of the body corresponding to the fuel pressure sensor, the two groups of nozzles are located at a lower position of the first cavity, the connection piece is located above the nozzles in the first cavity, and the fuel pressure sensor is transversely installed in the first cavity and a tail end corresponds to the via.

In a preferred solution, the first fuel line is horizontally disposed on the inner wall of the first end cover, the second interface is disposed on an upper side of the first fuel line and corresponds to a position of the first interface, a lower side of the first fuel line extends out of first plug interfaces that are respectively plugged and fitted to the two groups of nozzles, and the two groups of first plug interfaces both communicate with the first fuel line.

In a preferred solution, a second end cover forming a third cavity is fixedly fitted on the other side of the body that is opposite to the first end cover, a second fuel line is horizontally disposed on an inner wall of the second end cover, two groups of nozzles are disposed through a side of the body that corresponds to the second end cover, second plug interfaces that are respectively plugged and fitted to the two groups of nozzles on a lower side extends out from the side of the second fuel line, and both of the two groups of second plug interfaces communicate with the second fuel line.

In a preferred solution, a third fuel line communicating the first fuel line and the second fuel line is integrally formed on a rear side wall of the body.

Beneficial effects of the utility model: During installation, the fuel pressure sensor is first installed on the connection piece, and then one end of the connection piece is plugged and fixed to the first interface of the body. When the first end cover covers the body, the other end of the connection piece just completes plugging and fitting to the second interface. Therefore, it can be avoided that a sensor and a cable are installed in narrow space, and components are prevented from pressing a wire, thereby greatly facilitating installation of the fuel pressure sensor, and resolving a problem of line pressing. Compared with the existing technology, the fuel pressure sensor is integrated on an air throttle body, and may be linked to control of the nozzle and the butterfly valve, to control a fuel injection quantity in real time when fuel pressure fluctuates, so that the control is more precise.

### BRIEF DESCRIPTION OF THE DRAWINGS

The following further describes the present utility model in detail with reference to the accompanying drawings and the specific embodiments.

FIG. 1 is a schematic diagram of an exploded structure of an air throttle body according to an embodiment;

FIG. 2 is a schematic diagram of an internal structure of a first end cover according to an embodiment;

FIG. 3 is a schematic diagram of a structure of an end surface of a body corresponding to a side of a fuel pressure sensor according to an embodiment;

FIG. 4 is a schematic diagram of a structure of an air throttle body obtained after a first end cover is removed according to an embodiment;

FIG. 5 is a schematic diagram of a structure of a connection piece and a fuel pressure sensor according to an embodiment; and

FIG. 6 is a schematic diagram of an internal structure of a second end cover according to an embodiment.

### DETAILED DESCRIPTION

The following further describes the present utility model with reference to the accompanying drawings.

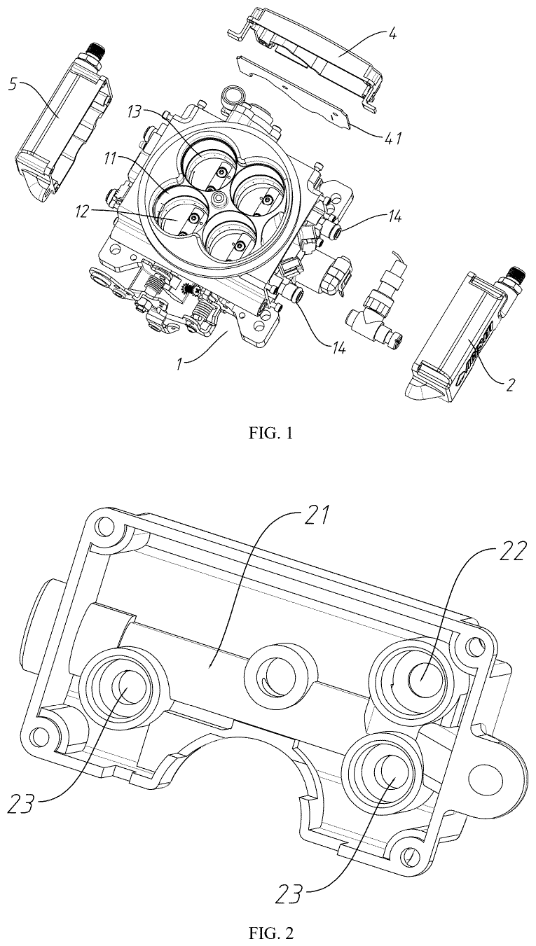

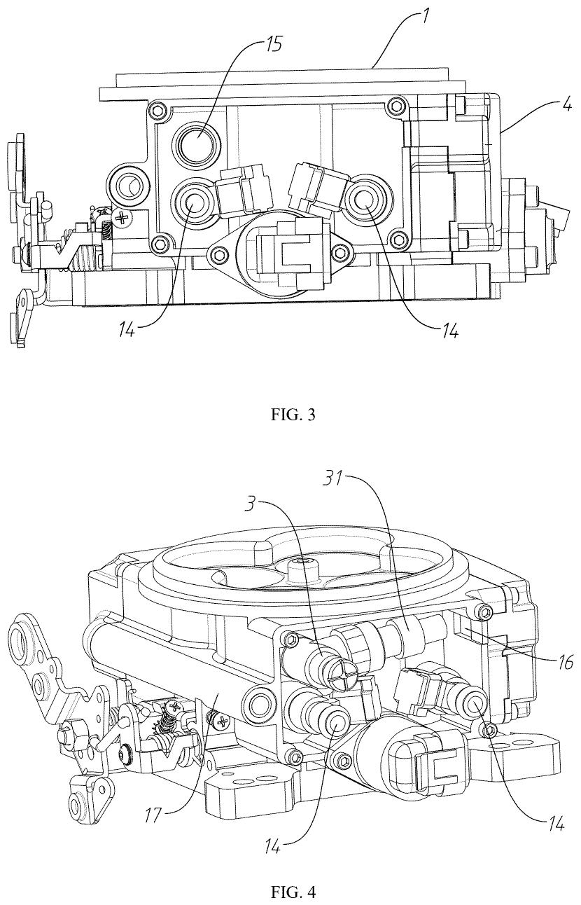

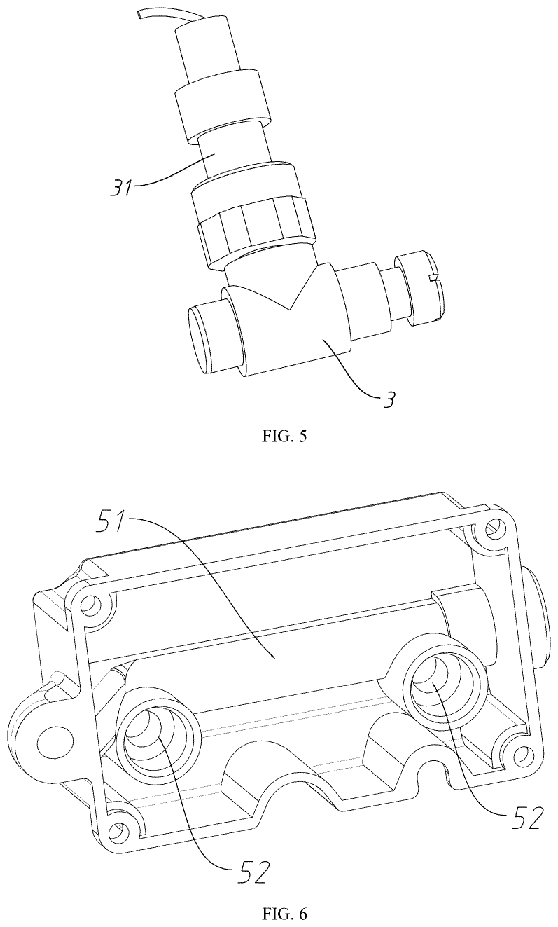

As shown in FIG. 1 to FIG. 6, an electrically controlled air throttle body structure is provided, including a roughly rectangular body 1, the body 1 having several air flow paths 11 that are arranged in parallel and that run up and down, and a butterfly valve 12 for controlling a ventilation quantity, atomization rings 13 for causing fuel to be atomized and to enter the air flow path 11, and several nozzles 14 that are disposed on a left or right side or two sides of the body 1 and communicate one-to-one with the atomization rings 13 being disposed on the air flow path 11. A first end cover 2 forming a first cavity is fixedly fitted to a left or right side of the body 1, a first fuel line 21 configured to supply fuel to the nozzle 14 is formed on an inner wall of the first end cover 2, a first interface 15 protrudes from a side wall of the body 1 opposite to the first end cover 2, a second interface 22 protrudes from a side, of the inner wall of the first end cover 2, toward the body 1, the second interface 22 communicates with the first fuel line 21, a tube-like connection piece 3 communicating with the second interface 22 is plugged and fitted between the first interface 15 and the second interface 22, and a fuel pressure sensor 31 is further installed on the connection piece 3 in vertical communication.

During installation, the fuel pressure sensor 31 is first installed on the connection piece 3, and then one end of the connection piece 3 is plugged and fixed to the first interface 15 of the body. When the first end cover 2 covers the body 1, the other end of the connection piece 3 just completes plugging and fitting to the second interface 22. Therefore, it can be avoided that a sensor and a cable are installed in narrow space, and components are prevented from pressing a wire, thereby greatly facilitating installation of the fuel pressure sensor 31, and resolving a problem of line pressing. Compared with the existing technology, the fuel pressure sensor 31 is integrated on the air throttle body, and may be linked to control of the nozzle 14 and the butterfly valve 12, to control the fuel injection quantity in real time when the fuel pressure fluctuates, so that the control is more precise.

In a preferred solution, in this embodiment, a panel 4 forming a second cavity is further fixedly fitted on a front side of the body 1, a line board 41 is installed in the second cavity, a via 16 is provided between the first cavity and the second cavity, and a wire of the nozzle 14 and a wire of the fuel pressure sensor 31 both pass through the via 16 and are electrically connected to the line board 41. Wires of parts are connected together on the line board 41 and then connected to the outside, to avoid a short circuit caused by scattered wiring of each wire.

In a preferred solution, in this embodiment, two groups of the nozzles 14 run through a side of the body 1 corresponding to the fuel pressure sensor 31, the two groups of nozzles 14 are located at a lower position of the first cavity, the connection piece 3 is located above the nozzles 14 in the first cavity, and the fuel pressure sensor 31 is transversely installed in the first cavity and a tail end corresponds to the via 16. Because the fuel pressure sensor 31 is transversely disposed at an upper part of the first cavity, during installation, the fuel pressure sensor 31 can be entirely seen by an installer, making installation convenient. The tail end of the fuel pressure sensor 31 corresponds to the via 16, making a length of a wire left in the first cavity very short, avoiding being pressed by another component to cause a short circuit.

In a preferred solution, in this embodiment, the first fuel line 21 is horizontally disposed on the inner wall of the first end cover 2, the second interface 22 is disposed on an upper side of the first fuel line 21 and corresponds to a position of the first interface 15, a lower side of the first fuel line 21 extends out of first plug interfaces 23 that are respectively plugged and fitted to the two groups of nozzles 14, and the two groups of first plug interfaces 23 both communicate with the first fuel line 21. During assembly, the first end cover 2 only needs to cover the body 1, so that the connection piece 3 is plugged and fitted to the second interface 22, and the first plug interface 23 is plugged and fitted to the nozzle 14. Therefore, the assembly is convenient and quick.

In a preferred solution, in this embodiment, a second end cover 5 forming a third cavity is fixedly fitted on the other side of the body 1 that is opposite to the first end cover 2, a second fuel line 51 is horizontally disposed on an inner wall of the second end cover 5, two groups of nozzles 14 are disposed through a side of the body 1 that corresponds to the second end cover 5, second plug interfaces 52 that are respectively plugged and fitted to the two groups of nozzles 14 on a lower side extends out from the side of the second fuel line 51, and both of the two groups of second plug interfaces 52 communicate with the second fuel line 51. Similarly, during assembly, the second end cover 5 only needs to cover the body 1, so that the second plug interface 52 is plugged and fitted to the nozzle 14. Therefore, the assembly is convenient and quick.

In a preferred solution, in this embodiment, a third fuel line 17 communicating the first fuel line 21 and the second fuel line 51 is integrally formed on a rear side wall of the body 1. The fuel lines are disposed on the first end cover 2, the rear side of the body 1, and the second end cover 5. An integration degree is high, installation space can be reduced, and integrity is stronger, so that the structure is more stable.

The above descriptions are not intended to limit the technical scope of the present utility model. Any alteration, equivalent change, or modification made to the above embodiments according to the technical essence of the present utility model shall fall within the scope of the technical solutions of the present utility model.

What is claimed is:

1. An electrically controlled air throttle body structure, comprising a roughly rectangular body, the body having several air flow paths that are arranged in parallel and that run up and down, and a butterfly valve for controlling a ventilation quantity, atomization rings for causing fuel to be atomized and to enter the air flow path, and several nozzles that are disposed on a left or right side or two sides of the body and communicate one-to-one with the atomization rings being disposed on the air flow path, wherein a first end cover forming a first cavity is fixedly fitted to a left or right side of the body, a first fuel line configured to supply fuel to the nozzle is formed on an inner wall of the first end cover, a first interface protrudes from a side wall of the body opposite to the first end cover, a second interface protrudes from a side, of the inner wall of the first end cover, toward the body, the second interface communicates with the first fuel line, a tube-like connection piece communicating with the second interface is plugged and fitted between the first interface and the second interface, and a fuel pressure sensor is further installed on the connection piece in vertical communication.

2. The electrically controlled air throttle body structure according to claim 1, wherein a panel forming a second cavity is further fixedly fitted on a front side of the body, a line board is installed in the second cavity, a via is provided between the first cavity and the second cavity, and a wire of the nozzle and a wire of the fuel pressure sensor both pass through the via and are electrically connected to the line board.

3. The electrically controlled air throttle body structure according to claim 2, wherein two groups of the nozzles run through a side of the body corresponding to the fuel pressure sensor, the two groups of nozzles are located at a lower position of the first cavity, the connection piece is located above the nozzles in the first cavity, and the fuel pressure sensor is transversely installed in the first cavity and a tail end corresponds to the via.

4. The electrically controlled air throttle body structure according to claim 3, wherein the first fuel line is horizontally disposed on the inner wall of the first end cover, the second interface is disposed on an upper side of the first fuel line and corresponds to a position of the first interface, a lower side of the first fuel line extends out of first plug interfaces that are respectively plugged and fitted to the two groups of nozzles, and the two groups of first plug interfaces both communicate with the first fuel line.

5. The electrically controlled air throttle body structure according to claim 4, wherein a second end cover forming a third cavity is fixedly fitted on the other side of the body that is opposite to the first end cover, a second fuel line is horizontally disposed on an inner wall of the second end cover, two groups of nozzles are disposed through a side of the body that corresponds to the second end cover, second plug interfaces that are respectively plugged and fitted to the two groups of nozzles on a lower side extends out from the side of the second fuel line, and both of the two groups of second plug interfaces communicate with the second fuel line.

6. The electrically controlled air throttle body structure according to claim 5, wherein a third fuel line communicating the first fuel line and the second fuel line is integrally formed on a rear side wall of the body.
